(19) United States
(12) Patent Application Publication
(10) Pub. No.: US 2007/0071406 A1
(43) Pub. Date: Mar. 29, 2007

(54) Video recording and reproducing apparatus and video reproducing apparatus

(75) Inventors: Tatsuo Koga, Osaka (JP); Ryosuke Ohtsuki, Osaka (JP); Yuji Yamamoto, Osaka (JP); Makoto Yamanaka, Osaka (JP); Satoru Matsumoto, Osaka (JP)

Correspondence Address: NDQ&M WATCHSTONE LLP, 1300 EYE STREET, NW, SUITE 1000 WEST TOWER, WASHINGTON, DC, 20005, US

(73) Assignee: Sanyo Electric Co., Ltd., Moriguchi (JP)

(21) Appl. No.: 11/527,400

(22) Filed: Sep. 27, 2006

(30) Foreign Application Priority Data
Sep. 28, 2005 (JP) P2005-281542
Feb. 28, 2006 (JP) P2006-054075

(51) Int. Cl. H04N 7/00

(52) U.S. Cl. 386/95

(57) ABSTRACT

A video recording and reproducing apparatus includes: an audio signal decoder configured to acquire an audio signal from an inputted audio-video signal; a recording section configured to record the inputted audio-video signal; a peak time point detecting section configured to detect, as a peak time point, a time point having a power value, which satisfies a predetermined condition, selected from among power values in the acquired audio signal; a digest scene extracting section configured to select a predetermined number of peak time points from among the detected peak time points, and to extract, as a digest scene, each piece of the audio-video signal within a predetermined digest scene cutting time period set to each of the selected peak time points in advance; and a reproduction controlling section configured to reproduce the extracted digest scenes.

### CROSS REFERENCE TO RELATED APPLICATION

This application is based upon and claims the benefit of priority from the prior Japanese Patent Application No. P2005-281542, filed on Sep. 8, 2005, and No. P2006-054075, filed on Feb. 28, 2006; the entire contents of which are incorporated herein by reference.

### BACKGROUND OF THE INVENTION

1. Field of the Invention

The present invention relates to a video recording and reproducing apparatus and a video reproducing apparatus, which automatically generate a digest scene in an audio-video signal.

2. Description of the Prior Art

Japanese Unexamined Patent Application Publication No. 2004-350134 discloses a conventional digest reproducing method.

In this method, a power (amplitude) value in an audio signal is analyzed to an audio-video signal. Then, a piece of the audio-video signal during a time period when the power value in the audio signal is over the threshold is selected as “a highlight scene”, thereby being reproduced.

This conventional digest reproducing method is a method of selecting, as the highlight scene, a piece of the audio-video signal during the time period when the power value in the audio signal is over the threshold, and of reproducing the selected audio-video signal.

Accordingly, by use of this method, it is not possible to reproduce pieces of the audio-video signal of the scene immediately preceding the time period when the power value in the audio signal is over the threshold.

For example, in a case of an audio-video signal of a soccer game, cheers of spectators reach the climax in a scene of a goal.

For this reason, the power value in the audio signal is over the threshold during a time period from the moment of the goal to the immediately following moments.

Thus, the piece of the audio-video signal during the above-mentioned time period can be selected as a scene used for making a digest (hereinafter, called a “digest scene”), thereby being reproduced.

In the case of the soccer game, however, the most highlight scenes are offense and defense at immediately preceding moments up to the goal.

Accordingly, a viewer would like to watch the scenes, in which the spectators are excited, at the moments immediately preceding the goal, the scene at the moment of the goal, and the scenes at the moments immediately following the goal.

Thus, even if the viewer watches the scenes following the moment when the spectators' cheers reach the climax, the viewer cannot enjoy the most highlight scene.

Moreover, in this method, the piece of the audio-video signal during the time period when the power value in the audio signal is over the threshold is selected as the digest scene, and then is reproduced.

For this reason, in a case where the time period when the power value is over the threshold is short, the time period for reproducing the digest scene is also short.

In an extreme case, for example, in a case where the power value in the audio signal is over the threshold for only one second, the digest scene for the only one second is reproduced. This makes the reproduced scene far from being enjoyable for the viewer.

Additionally, in order to set the threshold, it is necessary to analyze the targeted audio-video signal entirely. Accordingly, it is impossible to reproduce the digest scenes in real time by using a so-called “chasing reproduction” function, which is a problem.

### SUMMARY OF THE INVENTION

A first aspect of the present invention is summarized as a video recording and reproducing apparatus including: an audio signal decoder configured to acquire an audio signal from an inputted audio-video signal; a recording section configured to record the inputted audio-video signal; a peak time point detecting section configured to detect, as a peak time point, a time point having a power value, which satisfies a predetermined condition, selected from among power values in the audio signal acquired by the audio signal decoder; a digest scene extracting section configured to select a predetermined number of peak time points from among the peak time points detected by the peak time point detecting section, and to extract, as a digest scene, each piece of the audio-video signal within a predetermined digest scene cutting time period which is set to each of the selected peak time points in advance; and a reproduction controlling section configured to reproduce the digest scenes extracted by the digest scene extracting section.

A second aspect of the present invention is summarized as video reproducing apparatus which reproduces an audio-video signal recorded in a recording medium, including: a peak time point detecting section configured to detect, as a peak time point, a time point having a power value, which satisfies a predetermined condition, selected from among power values in an audio signal recorded in the recording medium; a digest scene extracting section configured to select a predetermined number of peak time points from among the peak time points detected by the peak time point detecting section, and to extract, as a digest scene, each piece of the audio-video signal within a predetermined digest scene cutting time period which is set to each of the selected peak time points in advance; and a reproduction controlling section configured to reproduce the digest scene extracted by the digest scene extracting section.

### BRIEF DESCRIPTION OF THE DRAWINGS

FIG. 1 is a block diagram of a video recording and reproducing apparatus according to a first embodiment of the present invention.

FIGS. 2(a) and 2(b) are explanatory diagrams for a detecting process of peak time points in the video recording and reproducing apparatus according to the first embodiment of the present invention.

FIG. 3 is a table indicating an example of peak time point information recorded by the video recording and reproducing apparatus according to the first embodiment of the present invention.

FIG. 4 is a table indicating an example of a play list generated by the video recording and reproducing apparatus according to the first embodiment of the present invention.

FIG. 5 is an explanatory diagram for a digest reproducing process in the video recording and reproducing apparatus according to the first embodiment of the present invention.

FIG. 6 is an explanatory diagram for the digest reproducing process in the video recording and reproducing apparatus according to the first embodiment of the present invention.

FIG. 7 is a flow chart indicating a recording process in the video recording and reproducing apparatus according to the first embodiment of the present invention.

FIG. 8 is a flow chart indicating a process of recording peak time point information in the recording process in the video recording and reproducing apparatus according to the first embodiment of the present invention.

FIG. 9 is a flow chart indicating the digest reproducing process in the video recording and reproducing apparatus according to the first embodiment of the present invention.

FIG. 10 is an explanatory diagram for the digest process of in the video recording and reproducing apparatus according to a second embodiment of the present invention.

FIG. 11 is an explanatory diagram for a digest reproducing process in the video recording and reproducing apparatus according to the second embodiment of the present invention.

FIG. 12 is a flow chart indicating the digest reproducing process in the video recording and reproducing apparatus according to the second embodiment of the present invention.

FIG. 13 is an explanatory diagram for a digest reproducing process in the video recording and reproducing apparatus according to a third embodiment of the present invention.

FIG. 14 is a flow chart indicating the digest reproducing process in the video recording and reproducing apparatus according to the third embodiment of the present invention.

FIG. 15 is a block diagram of a video recording and reproducing apparatus according to a fourth embodiment of the present invention.

FIG. 16 is an explanatory diagram for a digest reproducing process in the video recording and reproducing apparatus according to the fourth embodiment of the present invention.

FIG. 17 is a flow chart indicating a recording process in a video recording and reproducing apparatus according to a fifth embodiment of the present invention.

FIG. 18 is an explanatory diagram of a digest reproducing process in a video recording and reproducing apparatus according to a sixth embodiment of the present invention.

FIG. 19 is a flow chart indicating a process of selecting peak time points in a reproduction process in a video recording and reproducing apparatus according to a seventh embodiment of the present invention.

FIG. 20 is an explanatory diagram of a digest reproducing process in a video recording and reproducing apparatus according to an eighth embodiment of the present invention.

FIG. 21 is a block diagram of a video reproducing apparatus according to a ninth embodiment of the present invention.

FIG. 22 is a block diagram of a video reproducing apparatus according to a tenth embodiment of the present invention.

FIG. 23 is a diagram indicating an example of a table controlled by a peak time point detecting section in a video recording and reproducing apparatus of an eleventh embodiment of the present invention, and by a peak time point detecting section in a video reproducing apparatus of a twelfth embodiment of the present invention.

### DESCRIPTION OF THE PREFERRED EMBODIMENTS

Detailed descriptions will be given below of embodiments of the present invention with reference to the drawings.

(First Embodiment)

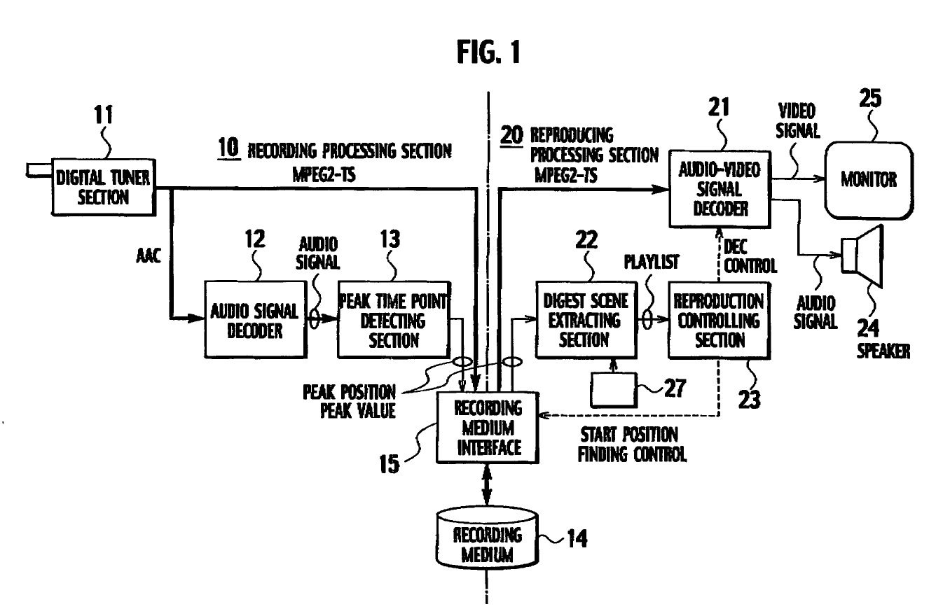

With reference to FIG. 1, descriptions will be given of a configuration of a video recording and reproducing apparatus according to a first embodiment of the present invention.

The video recording and reproducing apparatus of this embodiment includes a recording processing section 10 and a reproducing processing section 20.

The recording processing section 10 includes a digital tuner section 11, an audio signal decoder 12, a peak time point detecting section 13, a recording medium 14, and a recording medium interface 15.

The digital tuner section 11 is configured to perform a receiving process of an inputted audio-video signal. Specifically, the digital tuner section 11 is configured to receive and detect an inputted audio-video signal, and to decode the audio-video signal into MPEG2-TS.

The audio signal decoder 12 is configured to acquire an audio signal from the inputted audio-video signal. Specifically, the audio signal decoder 12 is configured to convert, into an audio signal, a compressed audio signal (AAC: Advanced Audio Code) included in the audio-video signal decoded by the digital tuner section 11.

The peak time point detecting section 13 is configured to detect, as a peak time point, a time point having a power value, which satisfies a predetermined condition, selected from among power values in the audio signal acquired by the audio signal decoder 12.

To be more precise, the peak time point detecting section 13 is configured to detect, as the peak time point, a time point having a power value which is a peak in the audio signal converted by the audio signal decoder 12, and to record, as peak time point information, the peak time point (peak position) and the power value (peak value) of the peak time point in the recording medium 14 through the recording medium interface 15.

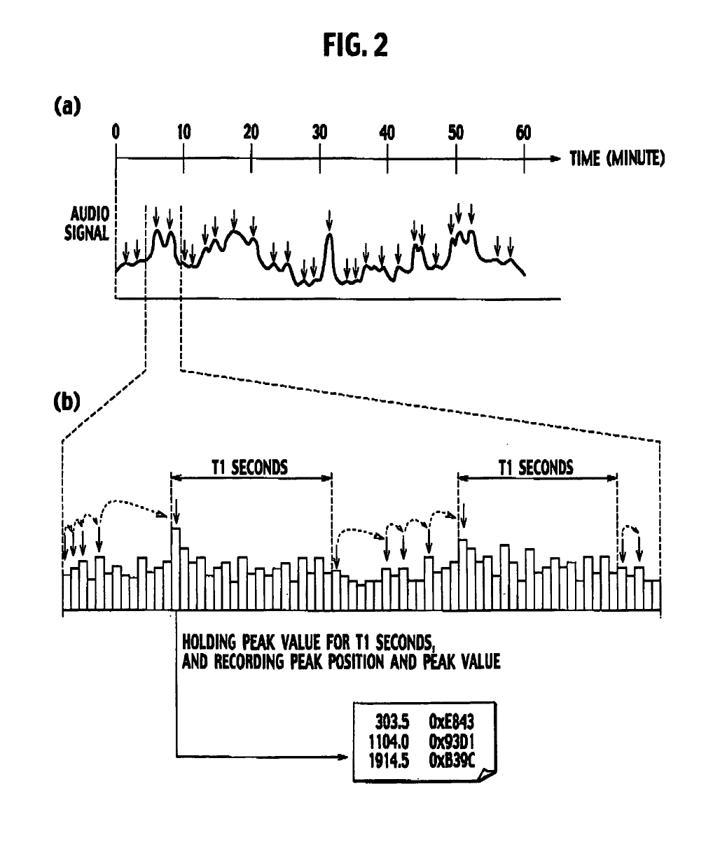

With reference to FIGS. 2A and 2B, descriptions will be given of a process in which the peak time point detecting section 13 detects and records the peak time point (the peak position) and the power value thereof (the peak value).

FIG. 2A shows a power (amplitude) curve of the audio signal, and FIG. 2B shows quantized power values in the audio signal in a part of the power curve of the audio signal.

As shown in FIG. 2B the peak time point detecting section 13 sequentially compares the power values in the audio signal with each other from the beginning.

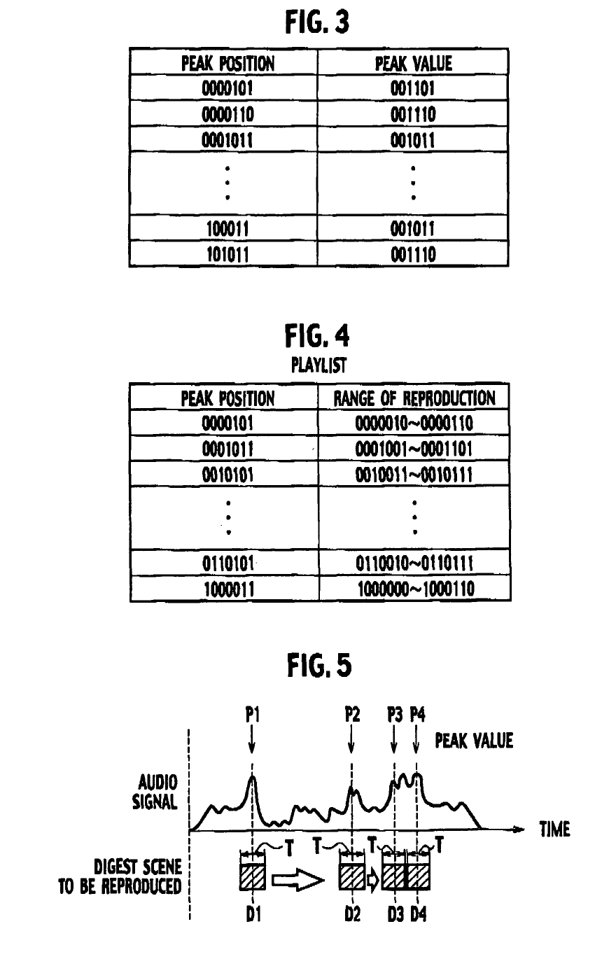

When a power value Pi at a certain time point is larger than the other power values within an ensuing fixed peak holding time period T1 (for example, 20 seconds), the peak time point detecting section 13 records the power value Pi (the peak value) and a time point having the power value Pi (the peak position) as the peak time point information (see FIG. 3).

Here, the peak holding time period is a fixed time period used for searching a peak time point.

If there is a certain time point of a power value larger than a power value of a start time point of searching the peak time point during the peak holding time period, the start time point is not determined as a peak time point, and the certain time point is determined as a start time point of next searching the peak time point.

On the other hand, if there is not a certain time point having a power value larger than a power value of a start time point of searching the peak time point during the peak holding time period, the start time point is determined as a peak time point.

Similarly, in every later case where a power value larger than a power value Pi at a certain time point does not appear within the ensuing fixed peak holding time period T1, the peak time point detecting section 13 views the time point having the power value Pi as the peak time point, and records the power value Pi and the peak time point as the peak time point information.

The peak time point detecting section 13 is configured to Continue performing the above-mentioned process of detecting and recording the peak time points, until a user performs a stop operation, or until a single audio-video signal (content) ends.

As a result, a series of peak time points and peak values (candidates for digest scenes) are recorded as the peak time point information for each audio-video signal in the recording medium 14, as shown in FIG. 3.

The recording medium 14 is configured by a hard disk, a DVD or the like, which is used for recording a digitally compressed audio-video signal inside.

The recording medium interface 15 is configured to record the audio-video signal and the peak time point information (described later) in the recording medium 14, and to read the audio-video signal and the peak time point information from the recording medium 14.

On the other hand, the reproducing processing section 20 includes an audio-video signal decoder 21, a digest scene extracting section 22, a reproduction controlling section 23, a speaker 24 and a monitor 25.

The audio-video signal decoder 21 is configured to take out a digitally compressed audio-video signal recorded in the recording medium 14, and to decode the digitally compressed audio-video signal into a video signal and an audio signal.

The digest scene extracting section 22 is configured to select a predetermined number of peak time points from among the peak time points detected by the peak time point detecting section 13, and then to extract, as a digest scene, each piece of the audio-video signal within a predetermined digest scene cutting time period which is set to each of the selected peak time points in advance

Here, the digest scene cutting time period is a time period for reproducing one scene to be used as a digest (i.e., one digest scene).

Specifically, the digest scene extracting section 22 is configured to select the above-mentioned peak time points up to the maximum number of the digest scenes (for example, 10 or 20) that can be reproduced within a predetermined digest reproducing time period.

Here, the digest reproducing time period is a time period during which a digest scene for each program can be reproduced.

Moreover, the digest scene extracting section 22 is configured to generate a playlist (see FIG. 4) including the extracted digest scenes, and to output the playlist to the reproduction controlling section 23.

As shown in FIG. 4, in the playlist, pieces of information for specifying each digest scene corresponding to each peak time point are listed in ascending order of the peak positions.

To be more precise, as shown in FIG. 4, in the playlist, each peak time point (each peak position) and a reproduction range corresponding to the each peak time point are stored in association with each other.

Here, the reproduction range is specified depending on the predetermined digest scene cutting time period which is set in advance for the peak time point.

The digest scene extracting section 22 is configured to set a reproduction start position of the digest scene and a reproduction end position of the digest scene, in such a way that a time period of reproducing the digest scene corresponding to the peak time point is the digest scene cutting time period T around the concerned peak time point (the peak position).

Note that, although the digest scene cutting time period T and the peak holding time period T1 are set to be equal in this embodiment, the present invention is not limited to this case. The digest scene cutting time period T and the peak holding time period T1 may be set at different time lengths from each other.

The reproduction controlling section 23 is configured to reproduce the digest scenes extracted by the digest scene extracting section 22.

To be more precise, the reproduction controlling section 23 is configured to read out pieces of the audio-video signal from the recording medium 14 through the recording medium interface 15, based on the playlist extracted by the digest scene extracting section 22.

The reproduction controlling section 23 is also configured to cause the audio-video signal decoder 21 to reproduce the read-out audio-video signal.

Upon receipt of the playlist as shown in FIG. 4 from the digest scene extracting section 22, the reproduction controlling section 23 is configured to read out pieces of the audio-video signal from the recording medium 14 sequentially from the earliest peak position. Each piece of the audio-video signal is within the digest scene cutting time period T corresponding to each of the peak time points recorded in the playlist as a reference.

Then, the reproduction controlling section 23 is configured to transmit the pieces of the audio-video signal to the audio-video decoder 21, and the audio-video decoder 21 reproduces the pieces of the audio-video signal.

As a result, the reproduction controlling section 23 can reproduce the digest scenes, which have high peak values (that is, large power values) in the audio-video signal recorded in the recording medium 14, from the beginning, up to the maximum number of the digest scenes that can be reproduced within the predetermined digest reproducing time period.

Thus, even in a case of a long audio-video signal, the highlights of the long audio-video signal can be automatically reproduced.

In short, as shown in FIG. 5, in response to each of the peak values P1 to P4 in the audio signal, the reproduction controlling section 23 can sequentially reproduce each pieces of the audio-video signal within a predetermined time period (a digest scene cutting time period) T before and after each of the peak values P1 to P4, respectively as the digest scenes D1 to D4.

Note that, in this embodiment, the digest scene extracting section 22 may include a genre specifying section 27.

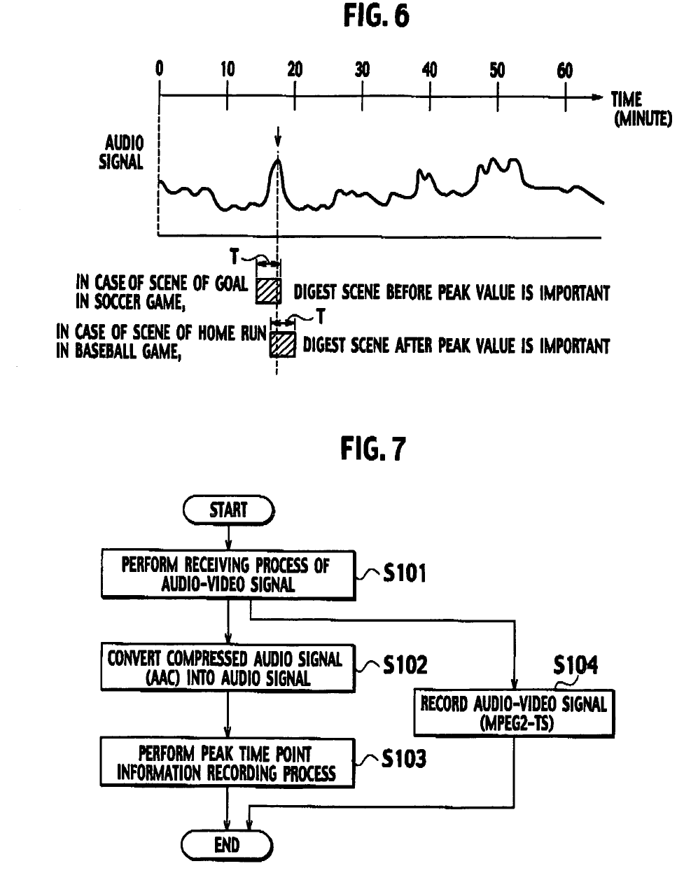

The genre specifying section 27 can be configured to specify one of a case where an audio-video signal to be reproduced is an audio-video signal representing a soccer game, a case where the audio-video signal to be reproduced is an audio-video signal representing a baseball game, or the like, as shown in FIG. 6.

Here, the digest scene cutting time period can be configured to set so that the peak time point is positioned in a middle of the digest scene cutting time period, the peak time point is positioned before the middle of the digest scene cutting time period, or the peak time point is positioned after the middle of the digest scene cutting time period, in accordance with a genre of the audio-video signal.

Furthermore, the genre shows a type of a program to be broadcasted by the audio-video signal specified by the Electronic Program Guide (EPG) and the like.

For example, in a case where a genre of an audio-video signal to be reproduced is an audio-video signal representing a soccer game, the genre specifying section 27 maybe configured to set most of the digest scene cutting time period to include the time period preceding a peak time point (a peak value), as shown in FIG. 6.

The purpose of this is to make it possible to reproduce a piece of the audio-video signal including scenes of offense and defense just before a goal, the moment of the goal, and the subsequent state of spectators.

On the other hand, in a case where the audio-video signal to be reproduced is an audio-video signal representing a baseball game, the genre specifying section 27 may be configured to set most of the digest scene cutting time period to include a time period following a peak time point (a peak value), as shown in FIG. 6.

The purpose of this is to make it possible to reproduce a piece of the audio-video signal including the following scenes: the pitcher throw the ball, the batter swings the bat and hits a home run, the trajectory of the flying ball, the ball falls in a stadium, and then spectators are excited.

Furthermore, the digest scene cutting time period is configured to be set so that a viewer can manually adjust the digest scene depending on the genre of the audio-video signal to be reproduced.

For example, the digest scene cutting time period can be set by specifying how many seconds before the peak time point at which the digest scene cutting time period starts.

The speaker 24 is configured to output the audio signal transmitted from the audio-video signal decoder 21 for purpose of the reproduction.

The monitor 25 is configured to output the video signal transmitted from the audio-video signal decoder 21 for purpose of the reproduction.

With reference to FIG. 7, firstly, descriptions will be given of a recording process in the recording processing section 10 of the video recording and reproducing apparatus according to the first embodiment of the present invention.

In step S101, the digital tuner section 11 receives and detects an audio-video signal transmitted, for example, by digital broadcasting, and decodes the audio-video signal into MPEG2-TS.

In step S102, the audio signal decoder 12 converts, into the audio signal, the compressed audio signal (AAC) included in the signal decoded by the digital tuner section 11.

In step S103, as mentioned above, the peak time point detecting section 13 performs, on the audio signal converted by the audio signal decoder 12, the process of recording the peak time point information.

Through the recording process, the peak time points (the peak positions) and the power values (the peak values) of the peak time points are detected, and sequentially recorded in the recording medium 14 through the recording medium interface 15.

In step S104, the digital tuner section 11 also records the audio-video signal which has been decoded and digitally compressed in the recording medium 14 through the recording medium interface 15.

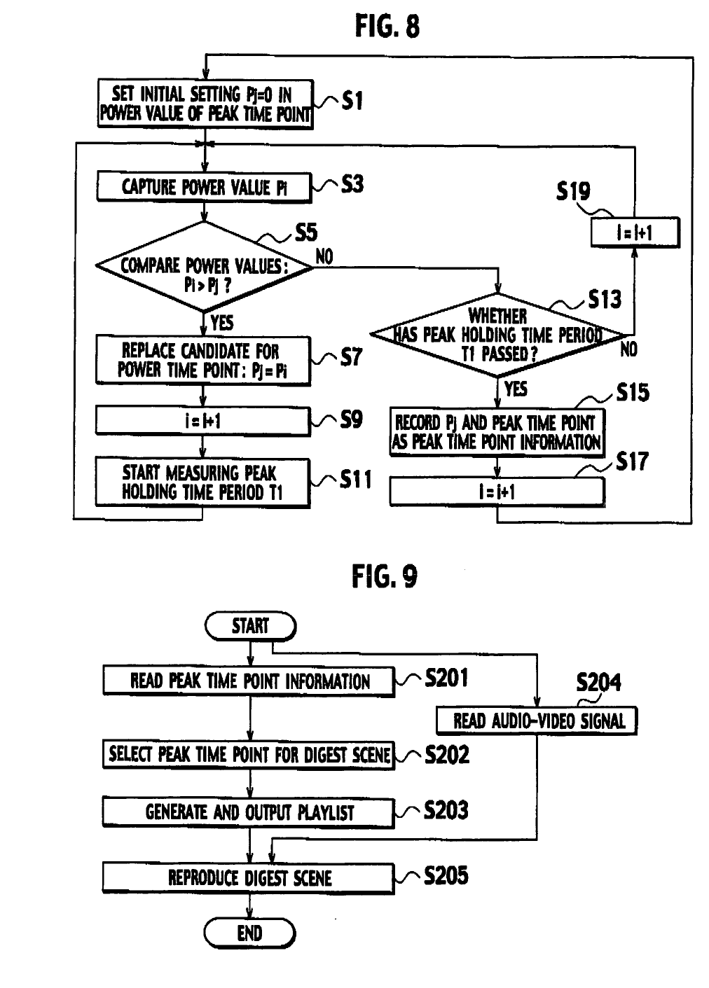

Here, with reference to FIG. 8, detailed descriptions will be given of the process of recording the peak time point information in step S103.

In step S1, the peak time point detecting section 13 sets “Pj=0” as the initial value of the power value of a peak time point candidate.

In step S3, the peak time point detecting section 13 sequentially captures power values Pi at each sampling timings.

In step S5, the peak time point detecting section 13 compares each of the captured power values Pi with the power value Pj of the peak time point candidate.

When a newly captured power value Pi is larger than the power value Pj of the peak time point candidate, the peak time point detecting section 13 replaces the power value Pj of the peak time point candidate with the newly captured power value Pi (steps S7 and S9).

Then, upon completion of the replacement by the newly captured power value of the peak time point candidate, the peak time point detecting section 13 resets the lapse of time to “0”, and restarts the process of step S3 and the following steps by using the power value Pj of the new peak time point candidate (step S11).

On the other hand, when a peak time point candidate with a power value Pi larger than the power value Pj of the peak time point candidate does not appear until the fixed peak holding time period T passes after the power value Pj of the peak time point candidate appears (step S13), the peak time point detecting section 13 records a time point having this power value Pj of the peak time point candidate and this power value Pj, as the peak time point information (step S15).

Once a peak time point is found as described above, the peak time point detecting section 13 resets the power Pj of the peak time point candidate to the initial state (steps S17 and S1), and restarts the process of step S3 and the following steps.

With reference to FIG. 9, secondly, descriptions will be given of a digest reproducing process in the reproduction processing section 20 of the video recording and reproducing apparatus of this embodiment.

In step S201, the digest scene extracting section 22 reads out the pieces of the peak time point information (see FIG. 3) recorded in the recording medium 14.

In step S202, the digest scene extracting section 22 selects the pieces of the peak time point information in descending order of the peak values, as the peak time points for the digest scenes.

In step S 203, as shown in FIG. 4, the digest scene extracting section 22 generates a playlist including the peak time points (the peak positions) for the digest scenes and the reproduction ranges of the digest scenes, and outputs the playlist to the reproduction controlling section 23.

In addition, in step S204, the audio-video signal decoder 21 reads out the audio-video signal recorded in the recording medium 14.

In step S205, in response to a command issued by the reproduction controlling section 23, the audio-video signal decoder 21 reproduces the digest scenes corresponding to the read-out audio-video signal.

According to the video recording and reproducing apparatus of this embodiment, it is possible to select a digest scene having an adequate length and including a highlight scene for reproduction, by extracting and reproducing each pieces of an audio-video signal within a predetermined digest scene cutting time period, which is set to a selected peak time point (a time point having a power value satisfying a predetermined condition) in advance, as a digest scene.

Therefore, it is possible to reproduce the digest scene so that it is easily viewable to a viewer.

According to the video recording and reproducing apparatus of this embodiment, it is possible to generate digest scenes up to the maximum number of digest scenes reproducible within a predetermined digest reproduction time period.

According to the video recording and reproducing apparatus of this embodiment, it is possible to reproduce adequate digest scenes including the above mentioned highlight scene, by setting the digest scene cutting time period so that the peak time point is positioned before the middle of the digest scene cutting time period when the highlight scene exists before the peak time point, and setting the digest scene cutting time period so that the peak time point is positioned after the middle of the digest scene cutting time period when the highlight scene exists after the peak time point.

According to the video recording and reproducing apparatus of this embodiment, it is possible to reproduce adequate digest scenes including the above mentioned highlight scene, by changing a method of the digest scene cutting time period to the peak time point between an audio-video signal in which the highlight scene exists before the peak time point such as an audio-video signal of a genre of soccer, and an audio-video signal in which the highlight scene exists after the peak time point such as an audio-video signal of a genre of baseball.

According to the video recording and reproducing apparatus of this embodiment, it is possible to extract a digest scene including the highlight scene, by determining a time point having a power value, which is a peak, in an audio signal, as a peak time point.

According to the video recording and reproducing apparatus of this embodiment, it is possible to avoid the situation in which adjacent digest scenes are overlapped even if the adjacent digest scenes are selected, by setting the peak holding time period and the digest scene cutting time period to be equal, so that a process in consideration of the overlapping of the digest scenes is not required.

(Second Embodiment)

A video recording and reproducing apparatus according to a second embodiment of the present invention is characterized in a reproducing process in a case where peak time points (candidates for digest scenes) appear successively within a fixed time period.

For this reason, the video recording and reproducing apparatus of this embodiment has a hardware configuration similar to that of the video recording and reproducing apparatus of the first embodiment as shown in FIG. 1.

However, the playlist generated by a digest scene extracting section 22 in a reproducing process section 20 of the video recording and reproducing apparatus of this embodiment is different from the playlist generated by the digest scene extracting section 22 in the reproducing process section 20 of the video recording and reproducing apparatus of the first embodiment.

For example, when there is a scene of a goal in a soccer game on television, the scene of the goal is played back on television immediately after the scene of the goal.

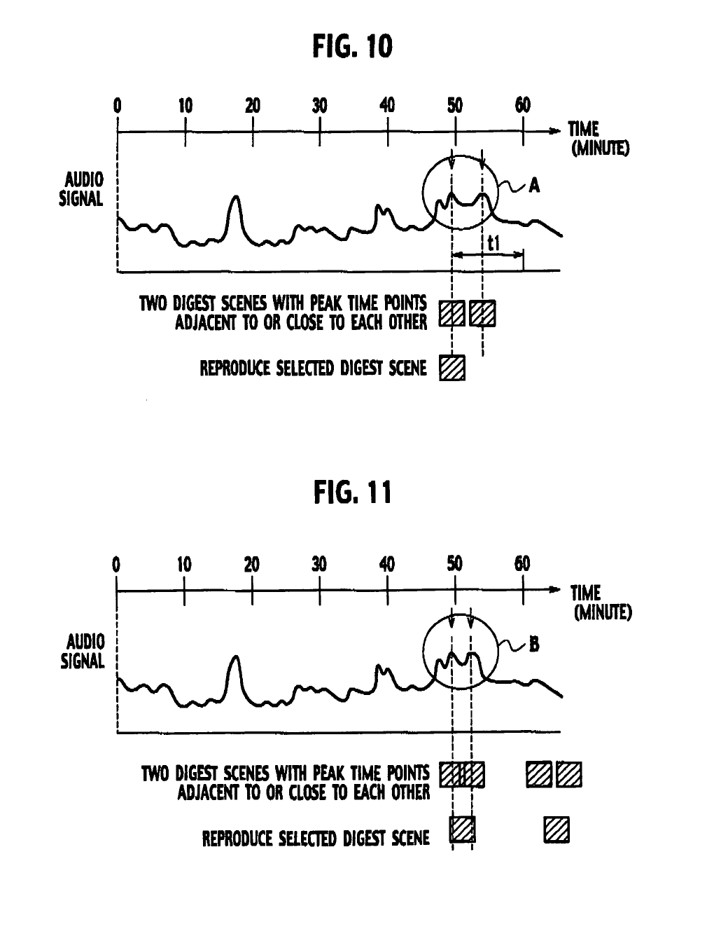

In this case, due to loud cheers by spectators, the audio signal has two peak time points within a fixed time period t1 as shown in a part “A” of FIG. 10. In this way, the two peak time points are recorded within a fixed time period t1.

Accordingly, as a result of reproducing the two digest scenes corresponding to the two peak time points, almost the same audio-video signal is reproduced twice.

Thus, in this case, it is favorable to reproduce only one of the former and the latter digest scenes.

The video recording and reproducing apparatus of this embodiment is useful in this case, and is configured to perform the following process.

In a case where the digest scene extracting section 22 selects a plurality of peak time points within a predetermined successive judgment time period t1, the reproduction controlling section 23 is configured to reproduce the piece of audio-video signal within the digest scene cutting time period T, which is extracted from the audio-video signal existing during a time period which starts from the beginning of the digest scene corresponding to the first peak time point of the plurality of selected peak time points, and which ends at the ending of the digest scene corresponding to the last peak time point of the plurality of selected peak time points.

For example, in the case where the two peak time points within a predetermined successive judgment time period t1 are selected, the digest scene extracting section 22 may be configured to reproduce any one of the two digest scenes corresponding to the former and the latter peak time points.

As a result, for example, in a case where a televised soccer game is recorded and digest scenes of the soccer game are reproduced, the video recording and reproducing apparatus of this embodiment is able to avoid successively reproducing the digest scenes which respectively represent the scene of a goal in real-time and the played-back scene of the goal broadcasted following the goal in real-time.

Moreover, as shown in apart “B” of FIG. 11, some contents of broadcasting may have a scene in which the peak values of the audio signal appear overlappingly, adjacently or closely.

In this case, as shown in FIG. 11, the digest scene extracting section 22 may be configured to combine these former and the latter digest scenes together, and may be configured to select a part of the combined digest scenes as a digest scene.

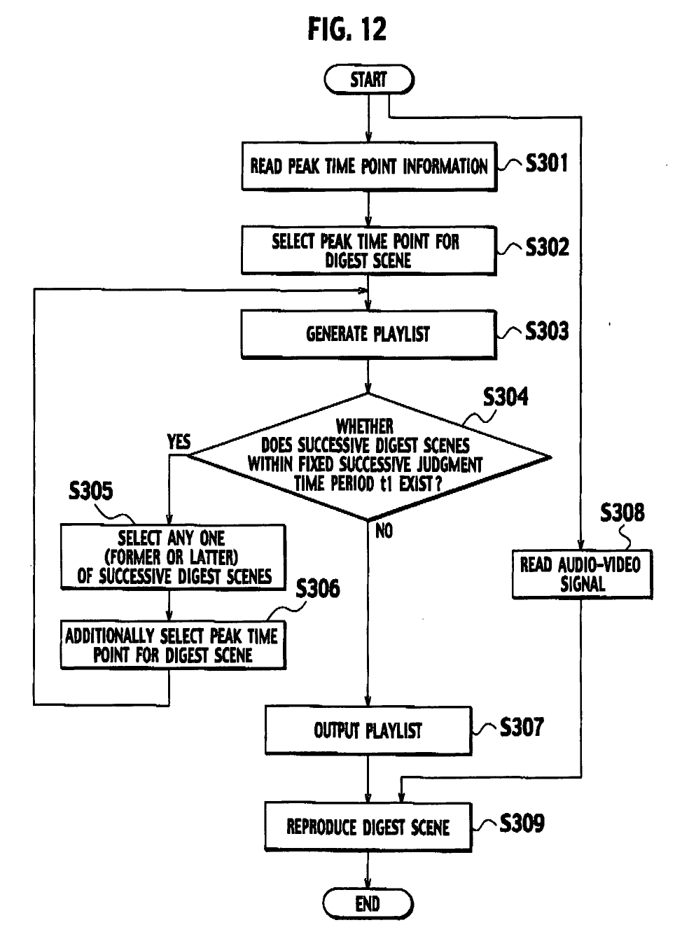

With reference to FIG. 12, descriptions will be given of a process of reproducing a digest in a reproduction processing section 20 of the video recording and reproducing apparatus of this embodiment.

Operations in steps S301 to S303 are the same as those in above-described steps S201 to S203 shown in FIG. 9.

Subsequently, in step S304, the digest scene extracting section 22 makes a judgment as to whether or not there are the digest scenes to be successively reproduced within the fixed successive judgment time period t1 in the generated playlist.

Then, in a case where there are the digest scenes to be successively reproduced within the fixed successive judgment time period t1, the digest scene extracting section 22 selects any one of the former and the latter digest scenes which a determination has been made to select in advance, and defines the selected digest scene as a peak time point (a candidate for the digest scene), in step S305.

Thus, one of the digest scenes is removed from the playlist. Accordingly, the digest scene extracting section 22 additionally selects a peak time point having the highest peak value among the peak time points which have not been selected as the peak time points for the digest scene. Thus, the playlist is renewed (steps S306 and S303).

Thereafter, the digest scene extracting section 22 makes a judgment of step S304 on the renewed playlist. When no digest scenes exist which are to be successively reproduced within a fixed successive judgment time period t1, the digest scene extracting section 22 outputs the playlist to the reproduction controlling section 23 in step S307.

Meanwhile, an audio-video signal decoder 21 reads out the audio-video signal recoded in the recording medium 14 in step S308.

Then, in response to a command issued by the reproduction controlling section 23, the audio-video signal decoder 21 reproduces the digest scenes of the read-out audio-video signal in step S309.

According to the video recording and reproducing apparatus of this embodiment, it is possible to avoid a situation in which both of almost the same digest scenes are reproduced, when, in an audio-video signal representing a soccer game, immediately after a scene of a goal in real-time (a digest scene corresponding to the first peak time point) is broadcasted, the scene of the goal (a digest scene corresponding to the second peak time point) is play back, for example.

According to the video recording and reproducing apparatus of this embodiment, it is possible to combine a plurality of digest scenes together, and select a part of the combined digest scenes as a digest scene.

(Third Embodiment)

A video recording and reproducing apparatus of a third embodiment of the present invention is also characterized in a reproducing process in a case where peak time points (candidates for digest scenes) appear successively within a fixed time period, as in the case of the video recording and reproducing apparatus of the second embodiment.

The video recording and reproducing apparatus of this embodiment has a hardware configuration similar to that of the video recording and reproducing apparatus of the first embodiment as shown in FIG. 1.

However, the playlist generated by a digest scene extracting section 22 in a reproducing process section 20 of the video recording and reproducing apparatus of this embodiment is different from the playlist generated by the digest scene extracting section 22 in the reproducing process section 20 of the video recording and reproducing apparatus of each of the first and the second embodiments.

In a soccer game, cheers of spectators become large in a scene of a shot, but the cheers tone down at once if the shot is failed. However, if the rebound is again shot and a goal is scored, the cheers of the spectators become large immediately.

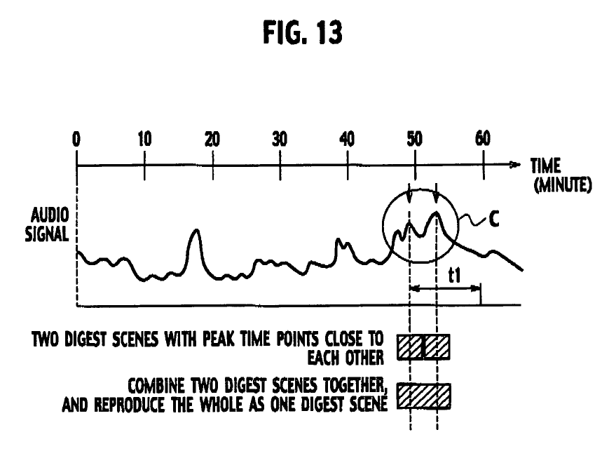

In a case where a televised soccer game including the above situation is recorded, the audio signal has two peak time points due to loud cheers by spectators within a fixed time period ti, as shown in a part “C” of FIG. 13. As a result, the two peak time points are recorded.

In a case where such a scene is reproduced as a digest scene, it is favorable to reproduce, as a digest scene, the entire scene from the scene of the first shot to the later scene of the successful goal.

The video recording and reproducing apparatus of this embodiment is useful in this case, and is configured to perform the following process.

In a case where the digest scene extracting section 22 selects a plurality of peak time points within a predetermined successive judgment time period t1, as shown in FIG. 13, the reproduction controlling section 23 is configured to reproduce the audio-video signal, which starts from the beginning of the digest scene corresponding to the first peak time point of the plurality of selected peak time points, and which ends at the end of the digest scene corresponding to the last peak time point of the plurality of selected peak time points.

As a result, for example, in the case where a televised soccer game is recorded and digest scenes of the soccer game are reproduced, the video recording and reproducing apparatus of this embodiment is able to reproduce, as a single digest scene, a series of highlight scenes where the first shot is failed, where the rebound is again shot, and where a goal is scored, without dividing them.

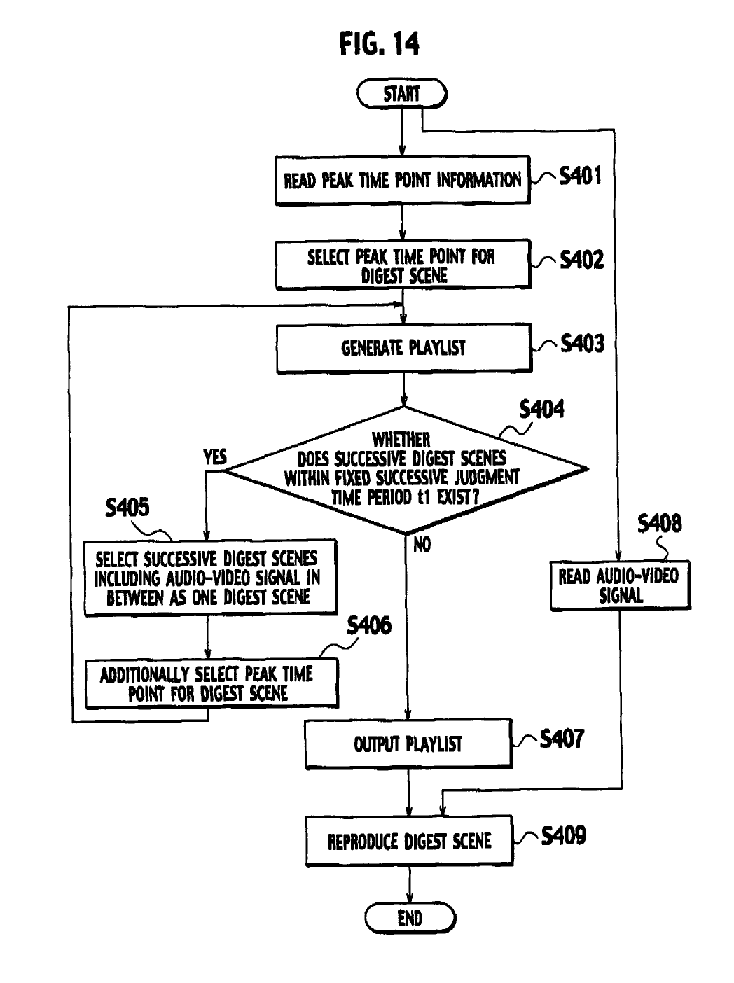

With reference to FIG. 14, descriptions will be given of a process of reproducing a digest in a reproduction processing section 20 of the video recording and reproducing apparatus of this embodiment.

Operations in steps S401 to S404 are the same as those in above-described steps S301 to S304 shown in FIG. 12.

Then, in a case where there are the digest scenes to be successively reproduced within the fixed successive judgment time period t1, the digest scene extracting section 22 combines these digest scenes with each other into a single digest scene, including the scenes in between, and defines the combined digest scenes as a new digest scene included in the playlist, in step S405.

Thus, one of the digest scenes is removed from the playlist. Accordingly, the digest scene extracting section 22 additionally selects a peak time point having the highest peak value from among the peak time points which have not been selected as the peak time points for the digest scenes, thereby renewing the playlist (steps S406 and S403).

Thereafter, the digest scene extracting section 22 makes a judgment of step S404 on the renewed playlist. When no more digest scenes exist which are to be successively reproduced within the fixed successive judgment time period t1, the digest scene extracting section 22 outputs the playlist to the reproduction controlling section 23, in step S407.

Meanwhile, an audio-video signal decoder 21 reads out the audio-video signal recoded in the recording medium 14 in step S408.

Then, the digest scenes of the read-out audio-video signal are reproduced in response to a command issued by the reproduction controlling section 23 in step S409.

According to the video recording and reproducing apparatus of this embodiment, for example, in an audio-video signal representing a soccer game, it is possible to reproduce, as a single digest scene, a series of highlight scenes where the first shot is failed, where the rebound is again shot, and where a goal is scored, without dividing them.

(Fourth Embodiment)

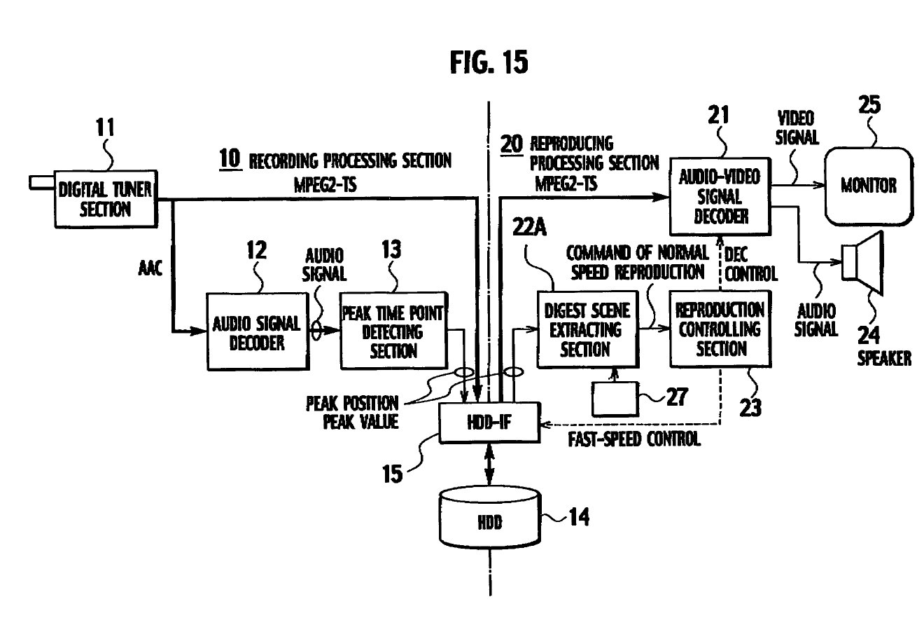

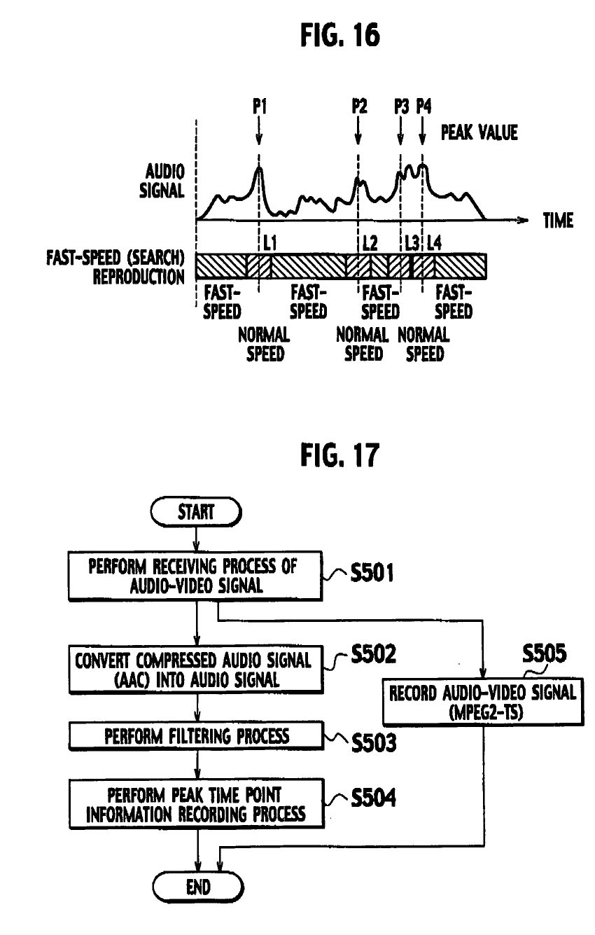

With reference to FIGS. 15 and 16, descriptions will be given of a video recording and reproducing apparatus according to a fourth embodiment of the present invention.

The video recording and reproducing apparatus of the fourth embodiment is characterized by reproducing only digest scenes (highlight scenes) at a normal speed during fast-speed reproduction of an audio-video signal (content).

The video recording and reproducing apparatus of this embodiment is also configured by a recording processing section 10 and a reproduction processing section 20, as is the case with the first embodiment.

Moreover, the recording processing section 10 of the video recording and reproducing apparatus includes a digital tuner section 11, an audio signal decoder 12, a peak time point detecting section 13, a recording medium 14 and a recording medium interface 15, as is the case with the configuration of the video recording and reproducing apparatus of the first embodiment.

The reproducing processing section 20 of the video recording and reproducing apparatus includes an audio-video signal decoder 21, a digest scene extracting section 22, a reproduction controlling section 23, a speaker 24 and a monitor 25, as is the case with the configuration of the video recording and reproducing apparatus of the first embodiment.

The reproduction controlling section 23, however, is configured to reproduce the piece of audio-video signal between digest scenes at a predetermined high speed, and to reproduce the pieces of audio-video signal corresponding to the digest scenes at the normal speed.

To be more precise, the digest scene extracting section 22 is configured to extract the digest scene as mentioned above, and to output a normal speed reproducing command to instruct to reproduce, at the normal speed, the piece of audio-video signal within a predetermined time period before and after the digest scene.

In addition, the reproduction controlling section 23 is configured to control fast-speed reproduction of the piece of audio-video signal recorded in the recording medium 14, and to control normal speed reproduction of the audio-video signal within a period in which the digest scene extracting section 22 is outputting the normal speed reproducing command.

Note that, the recording process in the recording processing section 10 of the audio recording and reproducing apparatus of this embodiment is the same as that in the recording processing section 10 of the audio recording and reproducing apparatus of the first embodiment.

Next, with reference to FIG. 15, descriptions will be given of a process for fast-speed reproduction in the audio recording and reproducing apparatus of this embodiment.

Normally, the reproduction controlling section 23 in the reproduction processing section 20 is configured to reproduce the audio-video signal recorded in the recording medium 14 from the beginning at a predetermined fast speed.

Then, during this fast-speed reproduction, once the digest scene extracting section 22 detects a peak time point recorded in the recording medium 14, for example, a peak position P1, the digest scene extracting section 22 is configured to define, as a highlight scene L1, a scene during a predetermined period before and after the peak position P1, and to output a normal speed reproducing command for the reproduction controlling section 23.

Upon receipt of the normal speed reproducing command, the reproduction controlling section 23 is configured to take control of switching to the normal speed reproduction during the highlight scene L1.

Thereafter, upon completion of the reproduction of the highlight scene L1, the reproduction controlling section 23 is configured to switch to the fast-speed reproduction, and to continue reproducing the audio-video signal.

Subsequently, once the digest scene extracting section 22 detects the next peak time point recorded in the recording medium 14, for example, a peak position P2, the digest scene extracting section 22 is configured to define, as a highlight scene L2, a scene during a predetermined period before and after the peak position P2.

After that, the digest scene extracting section 22 is configured to output the normal speed reproducing command for the highlight scene L2, to the reproduction controlling section 23.

Upon receipt of the normal speed reproducing command, the reproduction controlling section 23 is configured to take control of switching to the normal speed reproduction during the highlight scene L2.

Thereafter, the reproduction controlling section 23 is configured to handles a scene during the fixed period around each of the peak positions P3, P4, . . . as each of the highlight scenes L3, L4, . . . , and to switch between the fast-speed reproduction and the normal speed reproduction. Thus, the audio-video signal is reproduced up to the end.

According to the video recording and reproducing apparatus of the fourth embodiment of the present invention, while the fast-speed reproduction of a long audio-video signal is being performed, highlight scenes can be reproduced at the normal speed by automatically switching to the normal speed reproduction.

Note that, the video recording and reproducing apparatus of this embodiment may also have a configuration similar to the video recording and reproducing apparatus of each of the first to third embodiments.

Specifically, the video recording and reproducing apparatus can set a digest scene cutting time period with a focus on the side preceding the peak time point, or a digest scene cutting time period with a focus on the side following the peak time point depending on a genre of the audio-video signal.

In addition, in a case where the two highlight scenes successively appear within a short time period, the video recording and reproducing apparatus can combine these highlight scenes together, and reproduce these highlight scenes as a single highlight scene at the normal speed.

Alternatively, in this case, the video recording and reproducing apparatus can reproduce only one of the former and the latter highlight scenes at the normal speed.

Furthermore, according to the video recording and reproducing apparatus of this embodiment, once a highlight scene appears during the time period when the fast-speed reproduction of an accumulated audio-video signal is being performed, the highlight scene can be reproduced at the normal speed for a fixed time period. Thus, a viewer can watch the highlight scene carefully, while understanding the overall course of the audio-video signal.

(Fifth Embodiment)

With reference to FIG. 17, descriptions will be given of a video recording and reproducing apparatus of a fifth embodiment of the present invention.

The video recording and reproducing apparatus of this embodiment has the same configuration as that of the video recording and reproducing apparatus of each of the first to the fourth embodiments, except the following point.

That is, a peak time point detecting section 13 is configured to perform a filtering process on an audio signal acquired by an audio signal decoder 12, thereby to extract a piece of audio signal including only predetermined frequency component, and then to detect a peak time point in the extracted piece of audio signal.

To be more precise, the peak time point detecting section 13 is configured to set, in advance, a frequency band with a high proportion of audio frequency component effective to extract important scenes in a television broadcast program, and to perform filtering for passing the frequency components within the frequency band.

For example, in a case of a sumo bout program, it is considered that the most important scene is a scene from the “Tachiai (the moment when a bout starts)” to the “Shobu-Ari (the moment when a bout ends)”.

For this reason, a frequency band with a high proportion of frequency components of a Gyoji's (referee) shout, “Hakkiyoi (ready, go)” in the “Tachiai” scene is set in the peak time point detecting section 13 in advance, thereby increasing the possibility of detecting a time point having a power value of the shout as the peak time point. This increases the possibility of extracting, as a digest scene, the scenes from the “Tachiai” to the “Shobu-Ari”.

In addition, in a case of a soccer game program, a frequency band with a high proportion of frequency components of a whistling sound can be set in the peak time point detecting section 13, in advance.

Alternatively, in a case of a baseball game program, a frequency band with a high proportion of frequency components of voices (for example, “score a run” and the like) of an umpire and a commentator can be set in the peak time point detecting section 13, in advance.

Thereby, in these programs and the like, it becomes possible to increase the possibility of extracting important scenes as the digest scenes.

With reference to FIG. 17, descriptions will be given of a recording process in a recording processing section 10 of the video recording and reproducing apparatus of this embodiment.

In step S5O1, a digital tuner section 11 receives and detects an audio-video signal transmitted, for example, by digital broadcasting, thereby decoding the audio-video signal into MPEG2-TS.

In step S502, an audio signal decoder 12 converts, into an audio signal, the compressed audio signal (AAC) included in the audio-video signal decoded by the digital tuner section 11.

In step S503, the peak time point detecting section 13 performs the filtering process for passing the frequency components within the predetermined frequency band.

In step S504, by performing the process for recoding peak time point information on the above-filtered audio signal, the peak time point detecting section 13 detects the peak positions and the peak values of the respective peak time points, and sequentially records the detected ones in a recording medium 14 through a recording medium interface 15.

In step S505, the digital tuner section 11 also records the audio-video signal decoded and digitally compressed in the recording medium 14 through the recoding medium interface 15.

According to the video recording and reproducing apparatus of this embodiment, it is possible not only to reproduce, as the digest scene, a scene in which a power value in an audio signal becomes large, but also to reproduce, as the digest scene, an important scene which a viewer really would like to watch (for example, a “Tachiai” scene, which includes a frequency band of a Gyoji's shout “Hakkiyoi” in a sumo bout program, a scene with a high proportion of frequency components of a whistling sound in soccer program and the like).

(Sixth Embodiment)

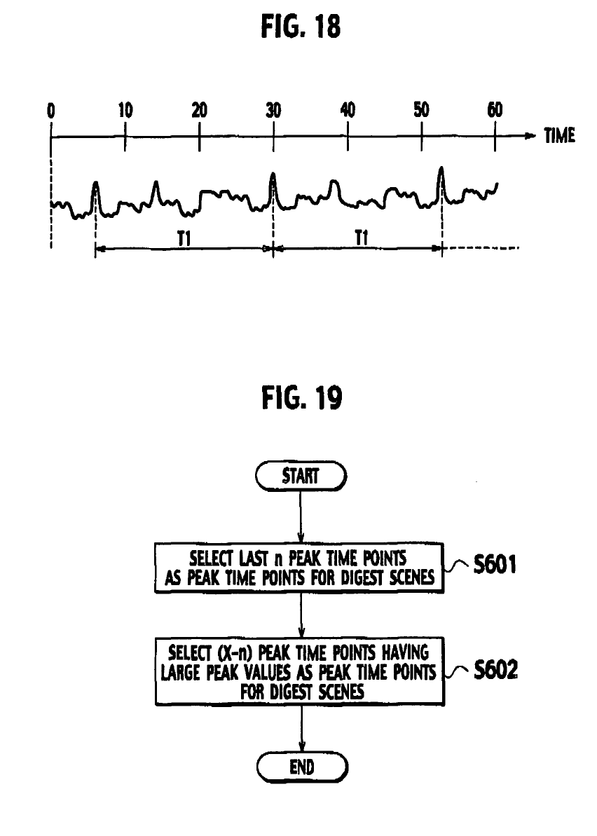

With reference to FIG. 18, descriptions will be given of a video recording and reproducing apparatus according to a 6the embodiment of the present invention.

The video recording and reproducing apparatus of this embodiment is the same as that of each of the first to the fifth embodiments mentioned above, except one point that the peak holding time period T1 is set to be repeated in a constant cycle.

For example, in a case of a sumo bout program, intervals between a “Tachiai” (a moment when a bout starts) and the next “Tachiai” (a moment when the next bout starts) are approximately regular. In other words, the bouts are repeated in a constant cycle.

Accordingly, by setting the peak holding time period T1 to be a time period from a bout to the next bout, it is possible to avoid extracting a plurality of peak time points in one bout.

Furthermore, it is preferable to flexibly set the peak holding time period T1 in response to a feature of a program.

For instance, in a case where the time point at which each race takes place is roughly fixed like a horse racing program, it is possible to avoid extracting a plurality of peak time points in one race by setting the peak holding time period T1 to the time period.

(Seventh Embodiment)

With reference to FIG. 19, descriptions will be given of a video recording and reproducing apparatus according to a seventh embodiment of the present invention.

The video recording and reproducing apparatus of this embodiment is the same as that of each of the first to the 6th embodiments mentioned above, except the following point.

That is, a digest scene extracting section 22 is configured to select each of a predetermined number of peak time points, based on at least one of the peak position and the power value of peak time point in the audio signal.

For example, in a sumo bout program, important scenes such as bouts in which an “Ozeki (sumo wrestler ranked at the second highest)” or a “Yokozuna (sumo wrestler ranked at the highest rank)” fights are included in the part of the audio-video signal towards the end.

For this reason, as shown in FIG. 19, the digest scene extracting section 22 may be configured to select the last n peak time points from the detected peak time points as the peak time points for digest scenes (step S601), and then, to select (x-n) peak time points in descending order of the peak value, as the peak time points for digest scenes (step S602).

Instead, for example, in a case where the time point for the main event is fixed like a horse racing program and a boxing match program, the digest scene extracting section 22 may be configured to preferentially select the peak time points around the time point for the main event, as the peak time points for digest scenes, from the detected peak time points.

Alternatively, the digest scene extracting section 22 may be configured to perform a process of weighting the peak position (peak time point) and the power value of each of the peak time points in accordance with a predetermined principle, and then, to make a selection for the peak time points for the digest scenes based on the result of the weighting process.

According to the video recording and reproducing apparatus of this embodiment, it is possible to preferentially select a peak time point around an important scene (or a time point for a main event) as a peak time point for the digest scene, in a sumo bout program where important scenes such as bouts in which an “Ozeki” or a “Yokozuna” fights are included in the part of the audio-video signal towards the end, or in a horse racing program and a boxing match program where the time point for the main event is fixed.

According to the video recording and reproducing apparatus of this embodiment, it is possible to preferentially select a peak time point corresponding to a scene of large peak value.

(Eighth Embodiment)

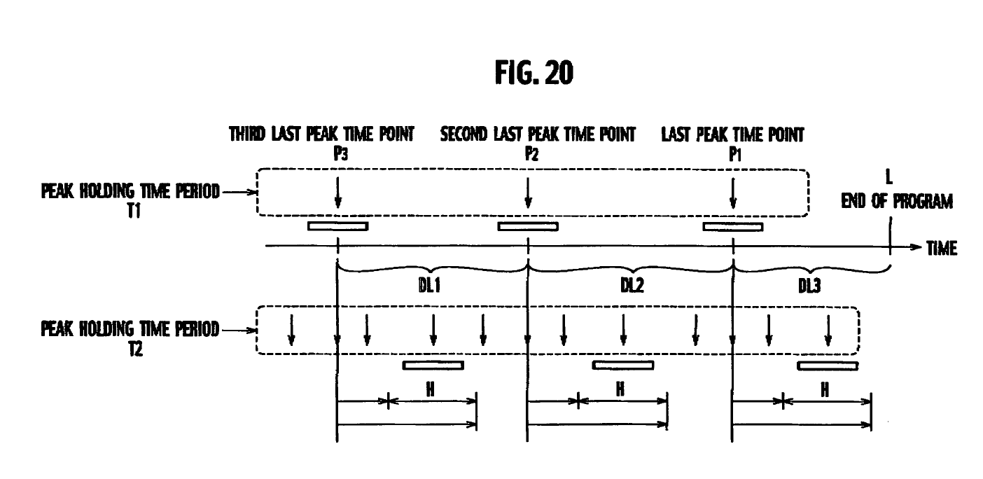

With reference to FIG. 20, descriptions will be given of a video recording and reproducing apparatus of an eighth embodiment of the present invention.

The video recording and reproducing apparatus of this embodiment is the same as that of each of the first to the seventh embodiments mentioned above, except the following point.

That is, a peak time point detecting section 13 is configured to detect the peak time points not only within the peak holding time period T1 but also within a second peak holding time period T2 shorter than the peak holding time period T1.

Moreover, the digest scene extracting section 22 is configured to extract the digest scenes using the peak time points detected within the second peak holding time period T2, in a case where a predetermined condition is satisfied.

For example, in order to never miss important scenes, such as bouts of sumo wrestlers of “ozekis” and of “Yokozunas” in a sumo bout program as well as main events in various sport programs, the peak time point detecting section 13, while detecting the peak time points within the peak holding time period T1, also detects the peak time points within the peak holding time period T2 which is shorter than the peak holding time period T1, as shown in FIG. 20.

In a case where a predetermined condition is satisfied, for example, in a time point specified as a time point when an important scene is highly likely to appear (the time point DL1 to DL3 in FIG. 20), the digest scene extracting section 22 is configured to extract the digest scenes using the peak time points detected within the peak holding time period T2.

In addition, the digest scene extracting section 22 may be configured to preferentially select, as the peak time points for the digest scenes, the peak time points within periods (periods “H” in FIG. 20) each of which is expected to be the period when a particularly important scene is highly likely to appear.

According to the video recording and reproducing apparatus of this embodiment, it is possible to reproduce digest scenes so as to never miss important scenes, such as bouts of sumo wrestlers of “Ozekis” and of “Yokozunas” in a sumo bout program as well as main events in various sport programs, by extracting digest scenes using peak time points detected within the second peak holding time period T2 shorter than the first peak holding time period T1.

(Ninth Embodiment)

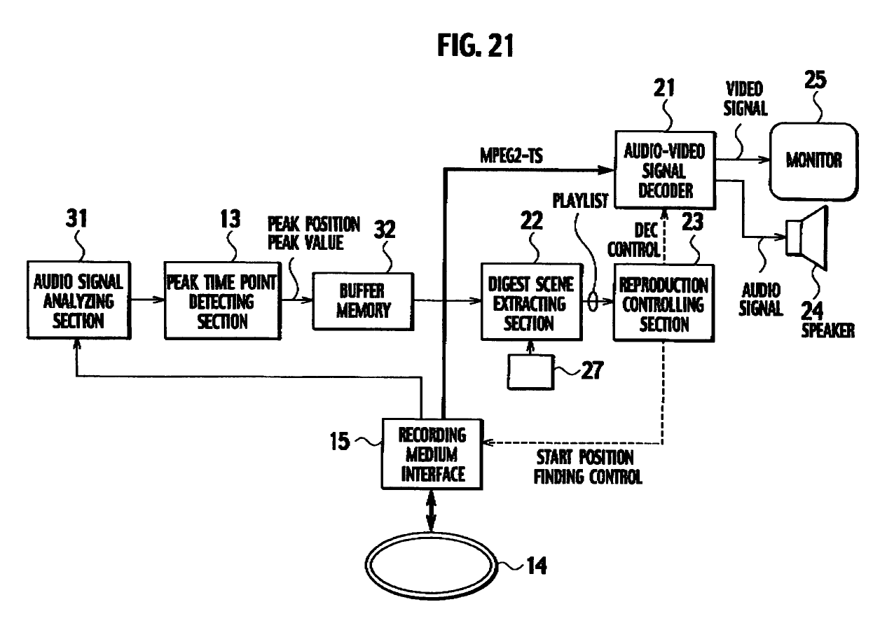

With reference to FIG. 21, descriptions will be given of a video reproducing apparatus according to a 9th embodiment of the present invention.

The video reproducing apparatus of this embodiment is applicable to a reproducing-only apparatus as well as to a recording and reproducing apparatus

As shown in FIG. 21, the video reproducing apparatus of this embodiment includes a recording medium interface 15, an audio signal analyzing section 31, a peak time point detecting section 13, a buffer memory 32, a digest scene extracting section 22, a reproduction controlling section 23, an audio-video signal decoder 21, a speaker 24 and a monitor 25.

The audio signal analyzing section 31 is configured to read ahead of time, and to analyze a power curve of an audio signal included in an audio-video signal recorded in the recording medium 14 such as HDD, DVD and the like, through the recording medium interface 15.

The peak time point detecting section 13 is configured to detect, as a peak time point, one of the power values in the audio signal recorded in the recording medium 14, as is the case with the peak time point detecting section 13 of the video recording and reproducing apparatus of each of the first to the 8th embodiments mentioned above.

To be more precise, when the power value in the audio signal at a certain time point is larger than the power values at the other time points within a fixed peak holding time period following the certain time point, the peak time point detecting section 13 is configured to detect, as the peak time point, the power value in the audio signal at the certain time point.

The buffer memory 32 is configured to temporarily record peak time point information including a peak time point (a peak position) and a peak value of the peak time point, which are detected by the peak time point detecting section 13.

The digest scene extracting section 22 has a configuration similar to that of the digest scene extracting section 22 of the video recording and reproducing apparatus of each of the first to the eighth embodiments.

That is, the digest scene extracting section 22 is configured to select a predetermined number of peak time points from among the peak time points which have been detected by the peak time point detecting section 13, and which have been recorded in the buffer memory 32.

In addition, the digest scene extracting section 22 is configured to extract, as the digest scenes, each pieces of the audio-video signal within the predetermined digest scene cutting time period which is set to each of the selected peak time points, in advance.

The reproduction controlling section 23 is configured to reproduce the digest scenes extracted by the digest scene extracting section 22, as is the case with the reproduction controlling section 23 of the video recording and reproducing apparatus of each of the first to the eighth embodiments mentioned above.

In a digest reproducing operation performed by the video reproducing apparatus of this embodiment, firstly, the audio analyzing section 31 acquires the audio signal by carrying out a process similar to the one performed by the audio signal decoder 12 of the video recording and reproducing apparatus of each of the first to the eighth embodiments mentioned above.

Secondly, the peak time point detecting section 13 records the peak time point information in the buffer memory 32 by carrying out a process similar to the one performed by the peak time point detecting section 13 of the video recording and reproducing apparatus of each of the first to the eighth embodiments mentioned above.

Thirdly, the digest scene extracting section 22 extracts the peak time point information from the buffer memory 32, and extracts the digest scenes by carrying out a process similar to the one performed by the digest scene extracting section 22 of the video recording and reproducing apparatus of each of the first to the 8th embodiments mentioned above.

The subsequent process is the same as the one in the digest reproducing operation performed by the video recording and reproducing apparatus of each of the first to the eighth embodiments mentioned above.

As a result, according to the video reproducing apparatus of this embodiment, even the reproducing-only apparatus can do the same thing as the video recording and reproducing apparatus of each of the first to eighth embodiments mentioned above.

Specifically, the video reproducing apparatus of this embodiment can reproduce the digest scenes with high peak values in the audio-video signal recorded in the recording medium 14 sequentially from the beginning up to the maximum number of the digest scenes which can be reproduced within the predetermined digest reproducing time period.

Thus, even in a case of a long audio-video signal, the highlight scenes of the long audio-video signal can be automatically reproduced.

(Tenth Embodiment)

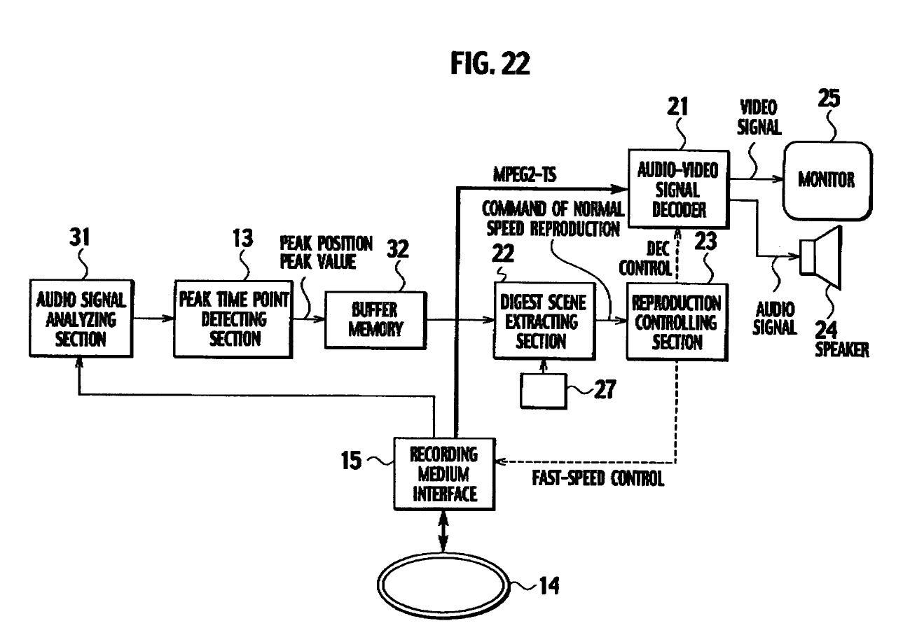

With reference to FIG. 22, descriptions will be given of a video reproducing apparatus according to a 10th embodiment of the present invention.

The video reproducing apparatus of this embodiment is similar to the video recording and reproducing apparatus of the above-mentioned fourth embodiment, and has the following feature.

That is, the reproduction controlling section 23 is configured to reproduce the audio-video signal between the digest scenes at a predetermined high speed, and to reproduce the piece of audio-video signal during the digest scenes to at a normal speed.

As shown in FIG. 22, the configuration of the video reproducing apparatus of this embodiment is the same as that of the video reproducing apparatus of the above-mentioned ninth embodiment (see FIG. 21), except functions of a digest scene extracting section 22 and a reproduction controlling section 23.

In addition, a fast-speed reproducing operation of the video reproducing apparatus of this embodiment is similar to that of the video recording and reproducing apparatus of the above-mentioned fourth embodiment.

Normally, in the video reproducing apparatus of this embodiment, the reproduction controlling section 23 is configured to reproduce the audio-video signal recorded in the recording medium 14, from the beginning at a predetermined speed for the fast-speed reproduction.

Then, during this fast-speed reproduction, once the digest scene extracting section 22 detects a peak time point recorded in the buffer memory 32, for example, a peak position P1, the digest scene extracting section 22 is configured to define, as a highlight scene L1, a scene in a predetermined period before and after the peak position P1, and to output the normal speed reproducing command for the highlight scene L1, to the reproduction controlling section 23.

Upon receipt of the normal speed reproducing command, the reproduction controlling section 23 is configured to take control of switching to the normal speed reproduction while the highlight scene L1 is reproduced.

Thereafter, upon completion of the reproduction of the highlight scene L1, the reproduction controlling section 23 is configured to switch to the fast-speed reproduction, and to continue reproducing the audio-video signal at the fast speed.

Subsequently, once the digest scene extracting section 22 detects the next peak time point recorded, for example, a peak position P2, in the buffer memory 32, the digest scene extracting section 22 is configured to define, as a highlight scene L2, a scene during a predetermined period before and after the peak position P2, and to output the normal speed reproducing command for the highlight scene L2 to the reproduction controlling section 23.

Upon receipt of the normal speed reproducing command, the reproduction controlling section 23 is configured to take control of switching to the normal speed reproduction while the highlight scene L1 is reproduced.

Thereafter, the reproduction controlling section 23 is configured to handles a scene during the fixed period around each of the peak positions P3, P4, as each of the highlight scenes L3, L4, . . . , and switches between the fast-speed reproduction and the normal speed reproduction, thereby reproducing the audio-video signal up to the end.

According to the video reproducing apparatus of this embodiment, even in a case of recording the audio-video signal in the recording medium 14 without extracting the peak time points during the recording, the digest scenes can be reproduced at a fast-speed as described above.

(Eleventh Embodiment)

With reference to FIG. 22, descriptions will be given of a video recording and reproducing apparatus according to an eleventh embodiment of the present invention.

The video recording and reproducing apparatus of this embodiment includes functions similar to those of the video recording and reproducing apparatus of the first embodiment, and has the following feature.

Specifically, in the video recording and reproducing apparatus of this embodiment, a peak time point detecting section 13 is configured to associate a genre of an audio-video signal and a peak holding time period T1 with each other, and to store them.

Thus, the peak time point detecting section 13 is configured to detect the above-mentioned peak time points by using the peak holding time period T1 associated with the genre of the inputted audio-video signal.

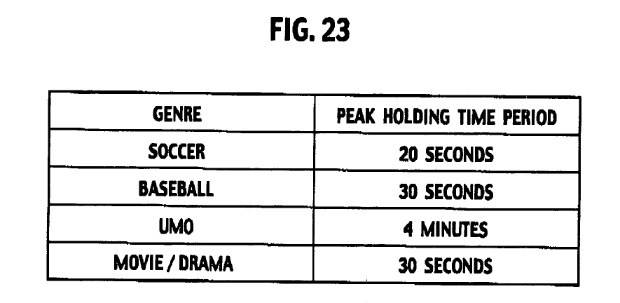

For example, the peak time point detecting section 13 is configured to associate the genre with the peak holding time period T1 of each of the respective audio-video signals, and stores them, by using a table such as shown in FIG. 23.

The peak time point detecting section 13 is configured to acquire the genre of the audio-video signal from the Electric Program Guide (EPG) and the like.

In the recording medium 14, the peak time point detecting section 13 is configured to records, as the peak time point information, the peak time points (the peak positions) and the power values (the peak values) of the each peak time points, which are detected by using the peak holding time period T1 associated with the acquired genre in the table such as shown in FIG. 23 (see FIGS. 2 and 3).

According to the video recording and reproducing apparatus according to this embodiment, it is possible to set peak time points by considering that the highlight scenes are different from each other per each genres, so as to reproduce adequate digest scenes according to the genres.

(Twelfth Embodiment)

With reference to FIG. 22, descriptions will be given of a video reproducing apparatus according to a twelfth embodiment of the present invention.

The video reproducing apparatus of this embodiment includes functions similar to those of the video reproducing apparatus of the 9th embodiment, and has the following feature.

That is, in the video reproducing apparatus of this embodiment, a peak time point detecting section 13 is configured to associate the genre with the peak holding time period T1 of each of the audio-video signals, and to store them.

Furthermore, the peak time point detecting section 13 is configured to detect the above-mentioned peak time points, by using the peak holding time period T1 associated with the genre of the inputted audio-video signal.

For example, the peak time point detecting section 13 is configured to associate the genre with the peak holding time period T1 of each of the audio-video signals, and stores them, by using a table such as shown in FIG. 23.

The peak time point detecting section 13 is configured to acquire the genre of the audio-video signal from the Electric Program Guide (EPG) and the like, and to detect, as the peak time point information, the peak time points (the peak positions) and the power values (the peak values) of the each peak time points, by using the peak holding time period T1 associated with the acquired genre in the table such as shown in FIG. 23 (see FIGS. 2 and 3).

Alternatively, the peak time point detecting section 13 may be configured to detect, as the peak time point information, the peak time points (the peak positions) and the power values (the peak values) of the each peak time points, by using the peak holding time period T1 associated with the genre in the table such as shown in FIG. 23, the genre specified for the audio-video signal by a user (see FIGS. 2 and 3).

According to the above embodiments of the present invention, it is possible to provide a video recording and reproducing apparatus and a video reproducing apparatus, which are capable of selecting and then reproducing, as digest scenes, highlight scenes to an audio-video signal adequately.

Additional advantages and modifications will readily occur to those skilled in the art. Therefore, the invention in its broader aspects is not limited to the specific details and the representative embodiments shown and described herein. Accordingly, various modifications may be made without departing from the scope of the general inventive concept as defined by the appended claims and their equivalents.

What is claimed is:

1. A video recording and reproducing apparatus comprising:
an audio signal decoder configured to acquire an audio signal from an inputted audio-video signal;
a recording section configured to record the inputted audio-video signal;
a peak time point detecting section configured to detect, as a peak time point, a time point having a power value, which satisfies a predetermined condition, selected from among power values in the audio signal acquired by the audio signal decoder;
a digest scene extracting section configured to select a predetermined number of peak time points from among the peak time points detected by the peak time point detecting section, and to extract, as a digest scene, each piece of the audio-video signal within a predetermined digest scene cutting time period which is set to each of the selected peak time points in advance; and
a reproduction controlling section configured to reproduce the digest scenes extracted by the digest scene extracting section.

2. The video recording and reproducing apparatus according to claim 1, wherein the digest scene extracting section is configured to select the peak time points up to the maximum number of the digest scenes reproducible within a predetermined digest reproduction time period.

3. The video recording and reproducing apparatus according to claim 1, the digest scene cutting time period is configured to set so that the peak time point is positioned in a middle of the digest scene cutting time period, the peak time point is positioned before the middle of the digest scene cutting time period, or the peak time point is positioned after the middle of the digest scene cutting time period.

4. The video recording and reproducing apparatus according to claim 3, the digest scene cutting time period is configured to set in accordance with a genre of the audio-video signal.

5. The video recording and reproducing apparatus according to claim 1, wherein,
when the digest scene extracting section selects a plurality of peak time points within a predetermined successive judgment time period, the reproduction controlling section is configured to reproduce a piece of the audio-video signal within the digest scene cutting time period, which is extracted from the audio-video signal existing during a time period which starts from a beginning of a first digest scene corresponding to the first peak time point of the plurality of selected peak time points, and which ends at an end of a last digest scene corresponding to the last peak time point of the plurality of selected peak time points.

6. The video recording and reproducing apparatus according to claim 1, wherein,
when the digest scene extracting section selects a plurality of peak time points within a predetermined successive judgment time period, the reproduction controlling section is configured to reproduce the audio-video signal existing during a time period which starts from a beginning of a first digest scene corresponding to the first peak time point of the plurality of selected peak time points, and which ends at an end of a last digest scene corresponding to the last peak time point of the plurality of selected peak time points.

7. The video recording and reproducing apparatus according to claim 1, wherein the reproduction controlling section is configured to reproduce the audio-video signal between the digest scenes at a predetermined high speed, and to reproduce the audio-video signal during the digest scene at a normal speed.

8. The video recording and reproducing apparatus according to claim 1, wherein,
when a power value in the audio signal at a certain time point is larger than any other power value in the audio signal within a fixed peak holding time period following the certain time point, the peak time point detecting section is configured to detect the power value in the audio signal at the certain time point as the peak time point.

9. The video recording and reproducing apparatus according to claim 8, wherein the peak holding time period and the digest scene cutting time period are set to be equal.

10. The video recording and reproducing apparatus according to claim 8, wherein the peak time point detecting section is configured to store a genre of the audio-video signal and the peak holding time period in association with each other, and to detect the peak time point using the peak holding time period associated with the genre of the inputted audio-video signal.

11. The video recording and reproducing apparatus according to claim 1, wherein the peak time point detecting section is configured to extract an audio signal including only a predetermined frequency component from the audio signal acquired by the audio signal decoder, and to detect the peak time points in the extracted audio signal.

12. The video recording and reproducing apparatus according to claims 8, wherein the peak holding time period is set to repeat in a predetermined cycle.

13. The video recording and reproducing apparatus according to claim 1, wherein the digest scene extracting section is configured to select the predetermined number of peak time points based on at least any one of the peak time point and the power value of the peak time point in the audio signal.

14. The video recording and reproducing apparatus according to claim 8, wherein:
the peak time point detecting section is configured to detect, in addition to the peak time point within the peak holding time period, a peak time point within another peak holding time period shorter than the peak holding time period; and
the digest scene extracting section is configured to extract the digest scene using the peak time point detected within the another peak holding time period when a certain condition is satisfied.

15. A video reproducing apparatus which reproduces an audio-video signal recorded in a recording medium, comprising
a peak time point detecting section configured to detect, as a peak time point, a time point having a power value, which satisfies a predetermined condition, selected from among power values in an audio signal recorded in the recording medium;
a digest scene extracting section configured to select a predetermined number of peak time points from among the peak time points detected by the peak time point detecting section, and to extract, as a digest scene, each piece of the audio-video signal within a predetermined digest scene cutting time period which is set to each of the selected peak time points in advance; and
a reproduction controlling section configured to reproduce the digest scene extracted by the digest scene extracting section.

16. The video reproducing apparatus according to claim 15, wherein the reproduction controlling section is configured to reproduce the audio-video signal between the digest scenes at a predetermined high speed, and to reproduce the audio-video signal during the digest scenes at a normal speed.

17. The video reproducing apparatus according to claim 15, wherein
when a power value in the audio signal at a certain time point is larger than any other power value in the audio signal within a fixed peak holding time period following the certain time point, the peak time point detecting section is configured to detect the power value in the audio signal at the certain time point as the peak time point.

18. The video reproducing apparatus according to claim 17, wherein the peak time point detecting section is configured to store a genre of the audio-video signal and the peak holding time period in association with each other, and to detect the peak time point using the peak holding time period associated with the genre of the inputted audio-video signal.
